(19) United States
(12) Patent Application Publication
(10) Pub. No.: US 2008/0218811 A1
(43) Pub. Date: Sep. 11, 2008

(54) KEYSTONE CORRECTING METHOD AND DISPLAY APPARATUS

(75) Inventor: In-Jae Yeo, Yongin-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Samsung Electro-Mechanics Co., Ltd., Suwon (KR)

(21) Appl. No.: 12/040,672

(22) Filed: Feb. 29, 2008

(30) Foreign Application Priority Data
Mar. 7, 2007 (KR) 10-2007-0022485

(51) Int. Cl. H04N 1/40

(52) U.S. Cl. 358/461

(57) ABSTRACT

Disclosed are a keystone correction method and a display apparatus using the same. The keystone correction method can include receiving a plurality of pixel data included in an image signal of a frame; computing a coordinate and data of a correction pixel from 3 row-directionally successive pixel data of the received pixel data; repeating the step of computing the coordinate and data of the correction pixel from all pixels of a row in the frame; and repeating the step of repeating the step of computing the coordinate and data of the correction pixel for all rows in the frame. With the present invention, the keystone can be corrected by using a minimum resource.

### CROSS-REFERENCE TO RELATED PATENT APPLICATIONS

This application claims the benefit of Korean Patent Application No. 10-2007-0022485, filed on Mar. 7, 2007, in the Korean Intellectual Property Office, the disclosure of which is incorporated herein in its entirety by reference.

### BACKGROUND OF THE INVENTION

1. Field of the Invention

The present invention relates to a display apparatus, more specifically to a method of correcting keystone distortion by using a minimum resource and a method using the same.

2. Background Art

While a conventional digital information processing method is impossible to process a large amount of data in real-time, an optical signal processing method can generally perform high-speed processing, parallel processing and large data amount processing. Also, studies on designs and manufactures of a binary phase filter, an optical logic gate, a light amplifier, a photoelectric element and an optical modulator by applying a spatial light modulation method are being developed. Particularly, the optical modulator is used in an optical memory, a light display, a printer, an optical interconnection and a hologram. A light beam scanning device using the optical modulator is being developed.

The light beam scanning device functions as forming a picture image by scanning a light beam in an image forming device such as a laser printer, an LED printer, an electronic photocopier, a word processor and a projector and spotting the light beam on a photosensitive medium.

As a projection television has been recently developed, an optical modulator and a light beam scanning device are being used as means that scans a light beam on a screen.

The display apparatus can include an optical modulator and a scanner. The optical modulator outputs a modulated beam of light corresponding to the beam of light incident from the light source. Here, the modulated beam of light outputted by the optical modulator corresponds to a one-dimensional image (i.e. vertical scanning line or a horizontal scanning line) formed by allowing a plurality of micro-mirrors to be arranged in a line and each of the micro-mirrors to deal with one pixel.

The scanner scans the modulated beam of light transferred from the optical modulator in a predetermined direction. This causes a plurality of one-dimensional image to be continually displayed. Finally, two-dimensional image is displayed on a screen.

FIG. 1 is a conceptual view showing that a display apparatus projects an image in accordance with the conventional art, and FIG. 2 is a front view showing a projected image in which keystone distortion is generated.

The display apparatus 100 projects and displays a two-dimensional image on an outside screen. The angle between the beam of light projected from the display apparatus 100 and the screen 12 is required to be close to 90 degree in order to allow the lengths of the top side and bottom side of the image to be identical. In this case, the two-dimensional image can be displayed without distortion on the screen 12. However, a trapezoid-type distortion is generated. At this time, the trapezoid-type distortion has different lengths of the top side and bottom side of the image according to the relative angle between the projected beam and the screen 12 generated. The trapezoid-type distortion is referred to as keystone.

### SUMMARY OF THE INVENTION

Accordingly, the present invention provides a digital correction method and a display apparatus applied with the same that can correct keystone by using a minimum resource.

The present invention also provides a digital correction method and a display apparatus applied with the same that can conserve the computing resource of a computing processor by performing the keystone correction through very simple computation and conserve memories because the keystone correction can be performed by using a buffer storing 4 pixel information.

The present invention also provides a digital correction method and a display apparatus applied with the same that can allow a compact projection system to be able to perform keystone correction by conserving computing resources and memories.

An aspect of the present invention features a method of correcting a keystone of a display apparatus. The method can include receiving a plurality of pixel data included in an image signal of a frame; computing a coordinate and data of a correction pixel from 3 row-directionally successive pixel data of the received pixel data; repeating the step of computing the coordinate and data of the correction pixel from all pixels of a row in the frame; and repeating the step of repeating the step of computing the coordinate and data of the correction pixel for all rows in the frame.

In the step of receiving the plurality of pixel data included in the image signal, pixel data of pixels included in a row of the frame can be successively inputted in a row direction, and then, pixel data of pixels included in a next row is inputted.

Here, the step of computing the coordinate and data of the correction pixel can include storing pixel data that is successively inputted in a buffer memory having 4 pixel buffers; computing a coordinate and data of the correction pixel from 3 successive pixel data stored in each pixel buffer of the buffer memory; and storing next pixel data in the pixel buffer that has not been used for the step of computing the coordinate and data of the correction pixel. Also, the step of computing the coordinate and data of the correction pixel and the step of storing next pixel data in the pixel buffer can be performed together.

In the step of computing the coordinate and data of the correction pixel, the coordinate of the correction pixel can be computed by using a distance between a row-directional center line of the frame and a second pixel datum of the 3 successive pixel data.

In the step of computing the coordinate and data of the correction pixel, the data of the correction pixel can be computed by determining a weight in the correction pixel of the 3 successive pixel data by use of a distance between a row-directional center line of the frame and a second pixel datum of the 3 successive pixel data.

Another aspect of the present invention features a display apparatus including a projection unit, loading image information according to a correction image signal on a beam of light transferred from a light source and projecting the image information on a screen; and an image processing unit, receiving an image signal of a frame, computing a coordinate and data of the correction pixel from 3 row-directionally successive pixel data of pixel data included in the received image signal, and generating and outputting the correction image signal including the correction pixel coordinate and the correction pixel data, computed by repeating the computation for all rows of the image signal and pixels in each of the rows.

The image processing unit can include a buffer memory including 4 pixel buffers, each of which stores one pixel data. Here, each pixel buffer of the buffer memory can store pixel data of the image signal that is successively inputted in a row direction, and the image processing unit can compute a coordinate and data of the correction pixel from 3 successive pixel data stored in each pixel buffer of the buffer memory. At this time, a next pixel datum of pixel data of the image signal can be stored in the pixel buffer that is not used in the image processing unit.

The image processing unit can compute the coordinate of the correction pixel by using a distance between a row-directional center line of the frame and a second pixel datum of the 3 successive pixel data.

Also, the image processing unit can compute the data of the correction pixel by determining a weight in the correction pixel of the 3 successive pixel data by use of a distance between a row-directional center line of the frame and a second pixel datum of the 3 successive pixel data.

The projection unit can include an optical modulator, outputting a modulated beam of light corresponding to an linear image by modulating an incident beam of light according to an inputted driving signal; a driving circuit, converting the inputted image control signal to the driving signal and outputting the driving signal to the optical modulator; a scanner, rotating according to a scanner control signal to scan the modulated beam of light transferred from the optical modulator on a screen and displaying a two-dimensional image; and the light source, emitting the incident beam of light to the modulator according to an inputted light source control signal. Here, the image processing unit can control an image projection performed by the optical modulator by providing the light source and the scanner with the light source control signal and the scanner control signal, synchronized with the image control signal. A plurality of micro-mirrors, arranged in a line to reflect the incident beam of light; and driving means, moving the micro-mirrors up and down according to the driving signal. Here, each of the micro-mirrors deals with a pixel of the screen.

### BRIEF DESCRIPTION OF THE DRAWINGS

These and other features, aspects and advantages of the present invention will become better understood with regard to the following description, appended Claims and accompanying drawings where:

FIG. 1 is a conceptual view showing that a display apparatus projects an image in accordance with the conventional art;

FIG. 2 is a front view showing a projected image in which keystone distortion is generated;

FIG. 3 illustrates a display apparatus using an optical modulator;

FIG. 4A is a perspective view showing a type of a diffractive optical modulator module using a piezoelectric element applicable to an embodiment of the present invention;

FIG. 4B is a perspective view showing another form of a diffractive optical modulator module using a piezoelectric element applicable to an embodiment of the present invention;

FIG. 4C is a plan view showing a diffractive optical modulator array applicable to an embodiment of the present invention;

FIG. 4D is a schematic view showing a screen generated with an image by a diffractive optical modulator array applicable to an embodiment of the present invention;

FIG. 5 illustrates an image before keystone is corrected and an image after keystone is corrected in accordance with an embodiment of the present invention;

FIG. 6 and FIG. 7 illustrate a keystone correction principle in accordance with an embodiment of the present invention;

FIG. 8A through FIG. 8C illustrate a method of mapping pixel data per generable case for keystone correction;

FIG. 9 is a flowchart illustrating a digital keystone correcting method in accordance with an embodiment of the present invention;

FIG. 10 illustrates the order of inputting pixel data of an image signal;

FIG. 11 illustrates the structure of a buffer memory for keystone correction in accordance with an embodiment of the present invention;

FIG. 12 illustrates the relation between a keystone corrected block and another corrected block in accordance with an embodiment of the present invention; and

FIG. 13 illustrates an original image, a keystone corrected image and a final image projected on a screen by using a display apparatus in accordance with an embodiment of the present invention.

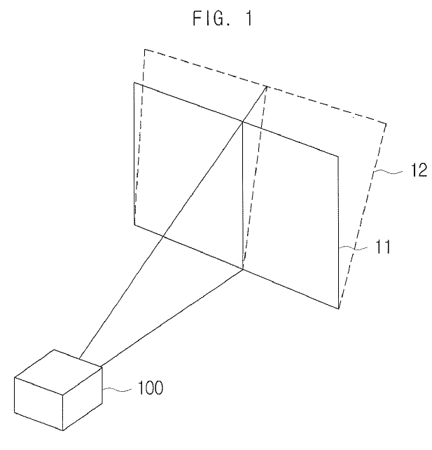

### DESCRIPTION OF THE EMBODIMENTS

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention. Throughout the drawings, similar elements are given similar reference numerals. Throughout the description of the present invention, when describing a certain technology is determined to evade the point of the present invention, the pertinent detailed description will be omitted.

Terms such as “first” and “second” can be used in describing various elements, but the above elements shall not be restricted to the above terms. The above terms are used only to distinguish one element from the other. For instance, the first element can be named the second element, and vice versa, without departing the scope of claims of the present invention. The term “and/or” shall include the combination of a plurality of listed items or any of the plurality of listed items.

When one element is described as being “connected” or “accessed” to another element, it shall be construed as being connected or accessed to the other element directly but also as possibly having another element in between. On the other hand, if one element is described as being “directly connected” or “directly accessed” to another element, it shall be construed that there is no other element in between.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

Unless otherwise defined, all terms, including technical terms and scientific terms, used herein have the same meaning as how they are generally understood by those of ordinary skill in the art to which the invention pertains. Any term that is defined in a general dictionary shall be construed to have the same meaning in the context of the relevant art, and, unless otherwise defined explicitly, shall not be interpreted to have an idealistic or excessively formalistic meaning.

Hereinafter, some embodiments of the present invention will be described in detail with reference to the accompanying drawings.

The keystone correction method to be described in the present invention is applicable to any display apparatus generating keystone. In particular, the projection type display apparatuses without a specific screen can be optimized for the keystone correction method. Event though the below description is related to the display apparatuses using the optical modulator of the projection type display apparatuses, it shall be evident that this by no means restrict the present invention.

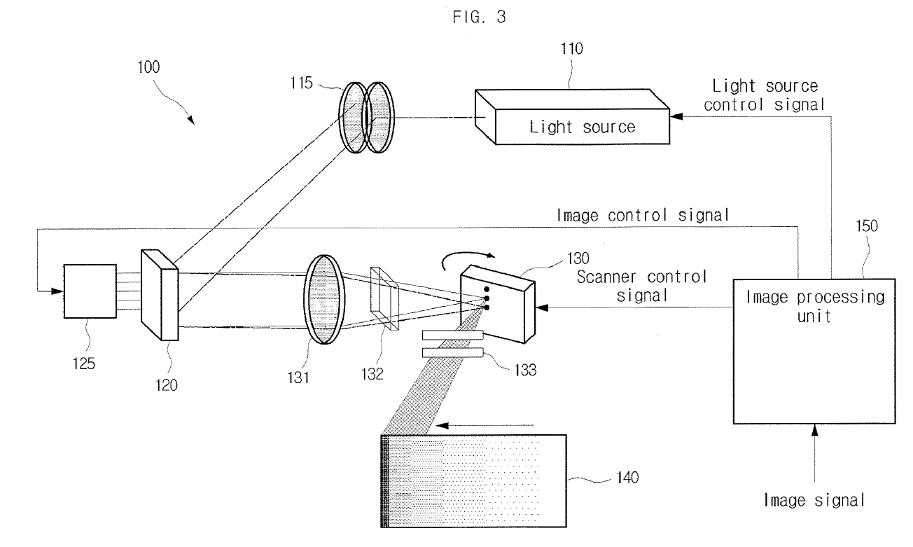

FIG. 3 illustrates a display apparatus using an optical modulator.

Referring to FIG. 3, the display apparatus 100 can include a light source 110, an optical modulator 120, a driving circuit 125, a scanner 130 and an image processing unit 150. In accordance with an embodiment of the present invention, the light source 110, the modulator 120, the driving circuit 125 and the scanner 130 can be included in a projection unit of the display apparatus 100.

The light source 110 can emit a beam of light to allow an image to be projected on a screen 140. The light source 110 can emit a white beam of light or any one of a red beam, a green beam and a blue beam of light, which are the three primary colors of light. Herein, the light source 110 can employ light amplification by stimulated emission of radiation (LASER), a light-emitting diode (LED) or a laser diode. In the case of emitting the white light, a color dividing unit (not shown) can be provided to divide the white beam of light into the red beam, the green beam and the blue beam of light.

A lighting optical system 115 can be placed between the light source 110 and the optical modulator 120. The lighting optical system 115 can reflect the light emitted from the light source 110 at a predetermined angle in order to allow the light to be concentrated on the optical modulator 120. If colors are divided by a color dividing unit (not shown), the operation of allowing the light to be concentrated can be additionally performed.

The optical modulator 120 can output modulated light according to a driving signal supplied from the driving circuit 220. The modulated light is the light emitted from the light source 120, which has undergone the modulation. The optical modulator 120, which is configured to include a plurality of micro-mirrors arranged in a line, can deal with a one-dimensional linear image corresponding to a vertical scanning line or a horizontal scanning in one image frame. In other words, when it comes to the one-dimensional linear image, the optical modulator 120 can output modulated light corresponding to incident light having a changed luminance by adjusting each displacement of the micro-mirrors corresponding to each pixel of the one-dimensional linear image according to a supplied driving signal.

The number of a plurality of micro-mirrors can be identical to that of a pixel constituting a vertical line of the image frame or its multiple. The modulated light, which is the light applied with image information (i.e. a luminance value of each pixel constituting a vertical scanning line) of a vertical scanning line to be projected later on the screen 140, can be 0^{th}, +n^{th} or −n^{th} order diffracted (reflected) light, n being a natural number.

The driving circuit 125 can supply to the optical modulator 120 a driving signal changing the luminance of modulated light outputted according to an image control signal supplied from the image processing unit 150. The driving signal that the driving circuit 220 supplies to the optical modulator 120 can be a driving voltage or a driving circuit.

A focusing optical system 131 can allow the modulated light outputted from the optical modulator 120 to be transferred to the scanner 130. The focusing optical system 131 can include at least one lens. Also, the relay optical system 350 adjusts the magnification, as necessary, to transfer the modulated light enlarged or contracted according to the size ratio of the optical modulator 120 and the scanner 130.

The scanner 130 can reflect modulated light incident from the optical modulator 120 at a predetermined angle and projects the light on the screen 140. At this time, the predetermined angle can be determined by a scanner control signal inputted from the image processing unit 150. The scanner control signal can be synchronized with an image control signal and allow the scanner 130 to be rotated at an angle. At this time, the modulated light can be projected on a vertical line position on the screen 140 corresponding to the scanner control signal at the angle.

In particular, the scanner control signal can include information related to a driving speed and a driving angle. The scanner 130 can be rotated according to the driving angel and speed in order that the modulated light incident from the optical modulator 120 can be projected on a position on the screen 140 at a time. The scanner 360 can be a polygon mirror, a rotating bar, or a Galvano mirror, for example.

The modulated light transferred from the optical modulator 120, as described above, can 0^{th}, +n^{th} or −n^{th} order diffracted light. Each diffracted light can be projected on the screen 140 by the scanner 130. In this case, since the path of each diffracted light is different, a slit 133 can be included. The slit 133 can allow desired order diffracted light to be selected and to be projected on the screen 140.

A projection optical system 132 can allow the modulated transferred from the optical modulator 120 to be projected on the scanner 130. Herein, the projection optical system 132 can include a projection lens (not shown).

The image processing unit 150 can receive an image signal corresponding to one image frame and generate a correction image signal corrected with keystone from the image signal to provide the generated correction image signal to the driving circuit 125. The image processing unit 150 can also provide a scanner control signal and a light source control signal to the scanner 130 and the light source 110, respectively. At this time, the scanner control signal and the light source controlling sign can be synchronized with an image control signal. One image frame can be displayed on the screen 140 by the image control signal, the scanner control signal and the light source control signal, which are linked with each other.

The image processing unit 150 can provide the driving circuit 125 with a correction image signal corresponding to luminance information to be desired to be displayed for each pixel forming a frame and adjust the scanning angle and the scanning speed of the scanner 130 to allow the vertical (or horizontal) line to be projected on the screen 140 according to the correction image signal.

The image processing unit 150 can correct the keystone of the top side or bottom side of an image as much as the amount determined by user input through buttons or switches on the display apparatus 100 or other input means. This is to correct various levels of keystone in a variety of environments by simple manipulation of a user because the level of keystone is not constantly generated according to the environment in which the display apparatus 100 is used.

The method of a correction image signal, which is the digital correcting method of keystone, will be described later with reference to the related drawings.

Below is described the optical modulator 120 applicable to the present invention.

The spatial optical modulator is mainly divided into a direct type, which directly controls the on/off state of light, and an indirect type, which uses reflection and diffraction. The indirect type can be further divided into an electrostatic type and a piezoelectric type. Here, the optical modulator is applicable to the present invention regardless of the operation type.

An electrostatic type grating optical modulator, as disclosed in U.S. Pat. No. 5,311,360, includes a plurality of regularly spaced reflective ribbons having reflective surfaces and suspended above an upper part of the substrate, the spaced distances of the reflective ribbons being adjustable.

First, an insulation layer is deposited onto a silicon substrate, followed by depositions of a silicon dioxide film and a silicon nitride film. Here, the silicon nitride film is patterned with the ribbons, and some portions of the silicon dioxide film are etched such that the ribbons can be maintained by a nitride frame on an oxide spacer layer.

The grating amplitude, of the modulator limited to the vertical distance d between the reflective surfaces of the ribbons and the reflective surface of the substrate, is controlled by supplying a voltage between the ribbons (i.e. the reflective surface of the ribbon, which acts as a first electrode) and the substrate (i.e. the conductive film at the bottom portion of the substrate, which acts as a second electrode).

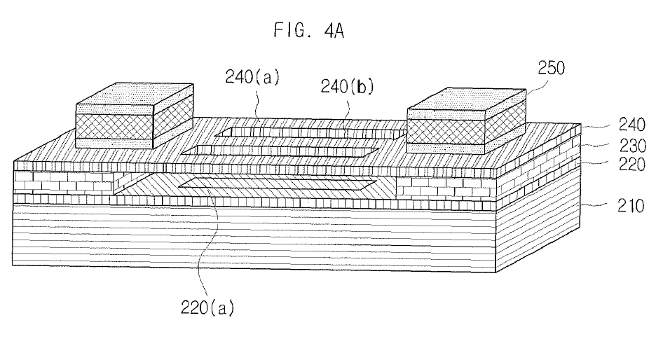

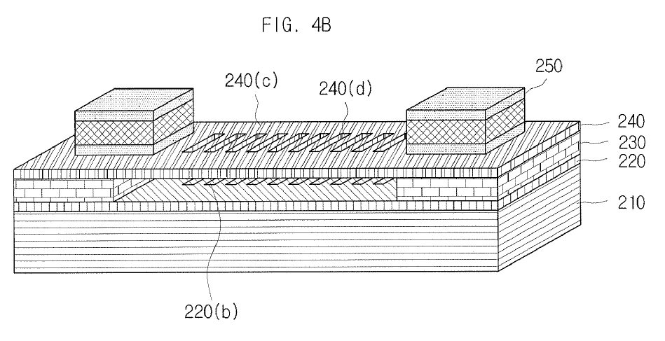

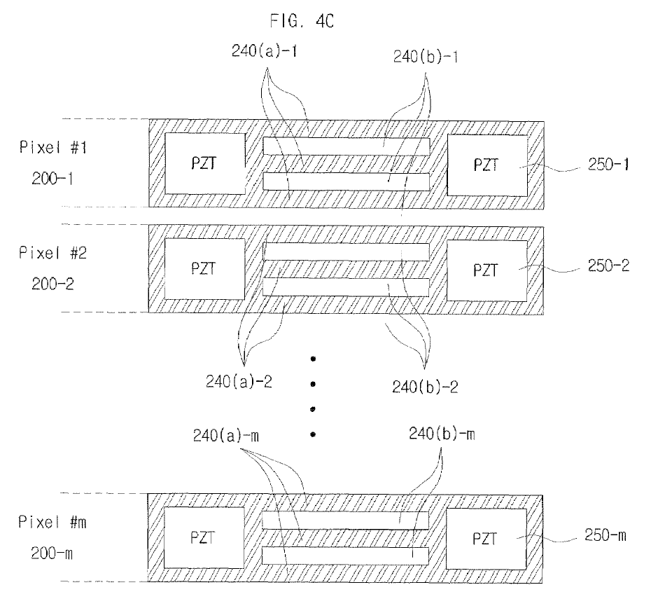

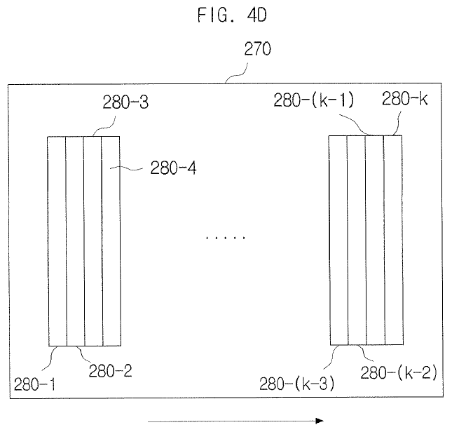

FIG. 4A is a perspective view showing a type of a diffractive optical modulator module using a piezoelectric element applicable to an embodiment of the present invention, and FIG. 4B is a perspective view showing another form of a diffractive optical modulator module using a piezoelectric element applicable to an embodiment of the present invention. Referring to FIG. 4A and FIG. 4B, the micro-mirror including a substrate 210, an insulation layer 220, a sacrificial layer 230, a ribbon structure 240 and a piezoelectric elements 250 is illustrated.

The substrate 210 is a commonly used semiconductor substrate, and the insulation layer 220 is deposited as an etch stop layer. The insulation layer 220 is formed from a material with a high selectivity to the etchant (an etching gas or an etching solution) that etches the material used as the sacrificial layer 230. Here, a lower reflective layer 220(a) or 220(b) can be formed on the insulation layer 220 to reflect incident beams of light.

The sacrificial layer 230 supports the ribbon structure 240 at opposite sides such that the ribbon structure 240 can be spaced by a constant gap from the insulation layer 220, and forms a space in the center part.

The ribbon structure 240 creates diffraction and interference in the incident light to perform optical modulation of signals. The ribbon structure 240 can be formed in a plurality of ribbon shapes, or can include a plurality of open holes 240(b) or 240(d) in the center portion of the ribbons. Also, the piezoelectric element 250 controls the ribbon structure 240 to move upwardly and downwardly according to upward and downward, or leftward and rightward contraction or expansion levels generated by the difference in voltage between the upper and lower electrodes. Here, the lower reflective layer 220(a) or 220(b) is formed in correspondence with the holes 240(b) or 240(d) formed in the ribbon structure 240.

For example, in case that the wavelength of a beam of light is λ, a first power is supplied to the piezoelectric elements 250. At this time, the first power allows the gap between an upper reflective layer 240(a) or 240(c), formed on the ribbon structure 240, and the lower reflective layer 220(a) or 220(b), formed on the insulation layer 220, to be equal to (2j)λ/4, k being a natural number. In the case of a 0^{th}-order diffracted (reflected) beam of light, the overall path length difference between the light reflected by the upper reflective layer 240(a) or 240(c) and the light reflected by the lower reflective layer 220(a) or 220(b) is equal to jλ, so that constructive interference occurs and the diffracted light renders its maximum luminance. In the case of +1^{st} or −1^{st} order diffracted light, however, the luminance of the light is at its minimum value due to destructive interference.

Also, a second power is supplied to the piezoelectric elements 250. At this time, the first power allows the gap between an upper reflective layer 240(a) or 240(c), formed on the ribbon structure 240, and the lower reflective layer 220(a) or 220(b), formed on the insulation layer 220, to be equal to (2j+1)λ/4, k being a natural number. In the case of a 0^{th}-order diffracted (reflected) beam of light, the overall path length difference between the light reflected by the upper reflective layer 240(a) or 240(c) formed on the ribbon structure 240 and the light reflected by the insulation layer 220 is equal to (2j+1)λ/2, so that destructive interference occurs, and the diffracted light renders its minimum luminance. In the case of +1^{st} or −1^{st} order diffracted light, however, the luminance of the light is at its maximum value due to constructive interference.

As a result of such interference, the micro-mirror can load a signal for one pixel on the beam of light by adjusting the quantity of the reflected or diffracted light. Although the foregoing describes the cases in which the gap between the ribbon structure 240 and the insulation layer 220 is (2j)λ/4 or (2j+1)λ/4, it shall be obvious that a variety of embodiments can be applied to the present invention, in which adjusting the gap between the ribbon structure 240 and the insulation layer 220 is able to control the luminance of light interfered by diffraction and/or reflection of the incident light.

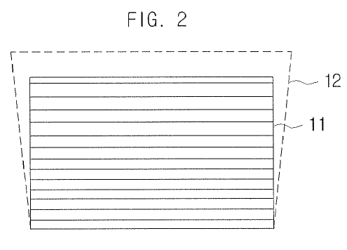

The below description is related to the micro-mirror shown in FIG. 2A. Hereinafter, the 0^{th}, +n^{st} or −n^{st} order diffracted (or reflected) light is referred to as modulated light. Here, n is a natural number.

FIG. 4C is a plan view showing the optical modulator 120 including the plurality of micro-mirrors shown in FIG. 4A.

Referring to FIG. 4C, the optical modulator 120 is configured to include m micro-mirrors 100-1, 100-2, . . . , and 100-m, each of which corresponds to a first pixel (pixel #1), a second pixel (pixel #2), . . . , and an m^{th} pixel (pixel # m), respectively, m being a natural number. The optical modulator 120 deals with image information with respect to 1-dimensional images of vertical or horizontal scanning lines (which are assumed to consist of m pixels), while each micro-mirror 100 deals with one pixel among the m pixels constituting the vertical or horizontal scanning line. Thus, the light reflected or diffracted by each micro-mirror is later projected as a 2-dimensional image on a screen by an optical scanning device.

For example, in the case of a VGA resolution of 640*480, the modulation is performed 640 times for 480 vertical pixels in one surface of an optical scanning device (not shown), to thereby generate one frame of display having a resolution of 640*480.

While the below description is related to the principle of optical modulation based on the first pixel (pixel #1), the same can obviously apply to other pixels.

In the embodiment of the present invention, it is assumed that the number of holes 240(b)-1 formed in the ribbon structure 240 is two. The two holes 240(b)-1 allow three upper reflective layers 240(a)-1 to be formed on an upper part of the ribbon structure 240. On the insulation layer 220, two lower reflective layers are formed in correspondence with the two holes 240(b)-1. Also, another lower reflective layer in correspondence with the gap between the first pixel (pixel #1) and the second pixel (pixel #2) is formed on the insulation layer 220. Accordingly, the number of the upper reflective layers 240(a)-1 is identical to that of the lower reflective layers per pixel, and as described with reference to FIG. 2A, it is possible to control the luminance of the modulated light by using the modulated light (i.e. 0^{th}-order diffracted light or ±1^{st}-order diffracted light).

FIG. 4D is a schematic view showing a screen generated with an image by a diffractive optical modulator array applicable to an embodiment of the present invention.

In particular, FIG, 2D illustrates that the light reflected and/or diffracted by vertically arranged m micro-mirrors 200-1, 200-2, . . . , and 200-m to be reflected by an scanner and then scanned horizontally on the screen 140, to thereby generate pictures 280-1, 280-2, 280-3, 280-4, . . . , 280-(k-3), 280-(k-2), 280-(k-1), and 280-k. One image frame can be projected in the case of one rotation of the optical scanning device. Here, although the scanning is performed from the left to the right (i.e. the direction indicated by the arrow), it is apparent that images can be scanned in another direction (e.g. in the opposite direction).

The present invention can be applied to the display apparatuses including the aforementioned one-dimensional diffractive optical modulator. Also, the present invention can be applied to the mobile display apparatuses, which are the projection type display apparatuses, included in the portable electronic apparatuses having various multimedia functions (e.g. mobile phones, personal digital assistants (PDA) and laptop computers) in order to reduce power consumption.

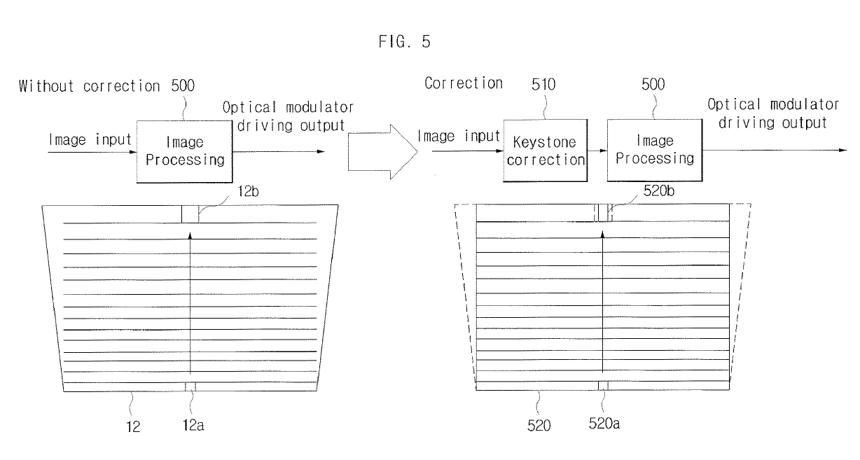

FIG. 5 illustrates an image before keystone is corrected and an image after keystone is corrected in accordance with an embodiment of the present invention.

In case that an inputted image signal undergoes the image processing operation 500, which generates a driving output to allow a corresponding image to be displayed on the screen 140 through the optical modulator 120, in the image processing unit 150, the two-dimensional image having a trapezoid shape may be finally displayed on the screen 140. Here, the top side of the trapezoid shape has the different length from the bottom side.

Referring to FIG. 5, if a pixel 12a of the bottom side is compared with a pixel 12b of the top side, it can be recognized that the size of the pixel 12b is enlarged in both a vertical direction and a horizontal direction.

Here, a frame buffer can be required to correct both the vertically directional size and the horizontally directional size. If the keystone distortion is generated, users may not clearly recognize the vertical change of pixel size visually. The horizontal change of pixel size may have an inconvenient and unstable affect on users in the cognitive aspect due to the change of the trapezoid shape.

Accordingly, in accordance with an embodiment of the present invention, the trapezoid image can be corrected to be a rectangular image by correcting the horizontal change of pixel size without the correction of the vertical change of pixel size. A two-dimensional image 520 can be displayed on the screen 140 by allowing the image signal inputted into the image processing unit 150 to undergo a keystone correction operation 510 and the image processing operation 500. In other words, the length of a pixel 520b in the top side of the image 520 can be identical or similar to that of a pixel 520a of the bottom side.

Hereinafter, the method of digitally correcting horizontally directional keystone in the image processing unit 150 will be described in detail with reference to the related drawings.

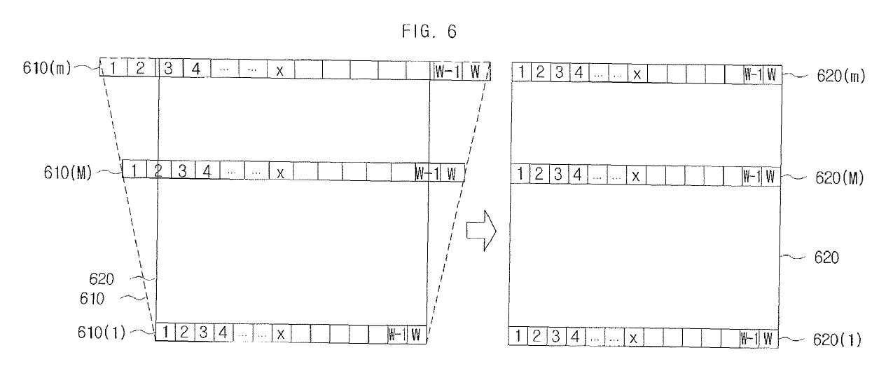

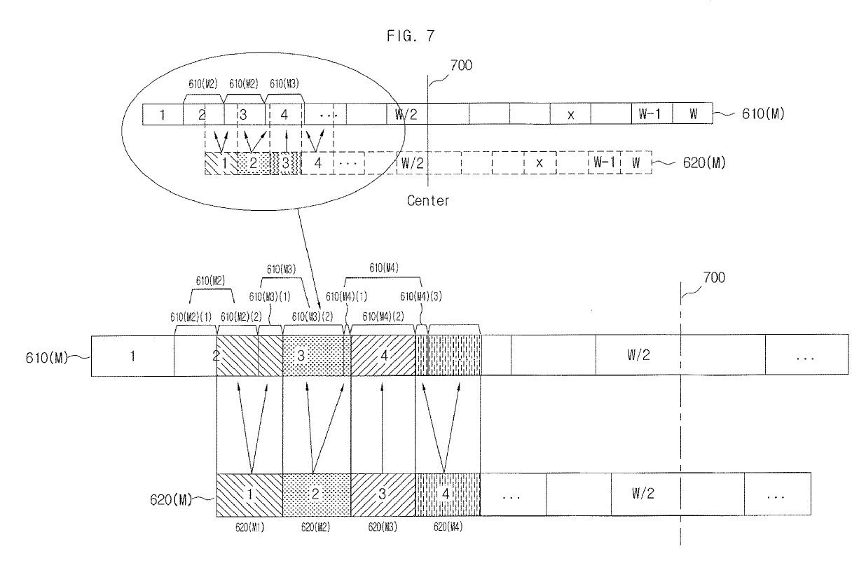

FIG. 6 and FIG. 7 illustrate a keystone correction principle in accordance with an embodiment of the present invention.

Referring to FIG. 6, it is assumed that a two-dimensional projected from the display apparatus 100 is displayed as the keystone having rows in the quantities of m including horizontally directional pixels in the quantities of W. Here, the keystone has its relative longer top side than its bottom side.

The two-dimensional image can undergo the keystone correction in order to have a rectangular shape 620, the top and bottom sides of which are identical. For this, a row 610(M), expected to be generated with the keystone, can be digitally corrected to allow all pixel information in the quantities of W of the row 610(M) to be included in a row 620(M) after the keystone is corrected. Here, 1≦M≦m.

Referring to FIG. 7, both the row 610(M) before correction and the row 620(M) after correction can be formed to include the pixels in the quantities of W. The row 610(M) can be contracted to be the same as the 620(M) after correction by the keystone correction. Here, each row 610(M) and 620(M) can have the same center line 700. Accordingly, the pixel data of each pixel of M^{th} row can be mapped to the pixel data of a corresponding pixel of the row 610(M) before correction.

Referring to an enlarged part A of FIG. 7, a first pixel 620(M1) after correction can be partially in contact with a second 610(M2) and a third pixel 610(M3) before correction, and a second pixel 620(M2) after correction can be partially in contact with the third 610(M3) and a forth pixel 610(M4) before correction. Also, a third pixel 620(M3) after correction can be included in a fourth pixel 610(M4) before correction, and a fourth pixel 620(M4) after correction can be partially in contact with the fourth pixel 610(M4) and a fifth pixel 610(M5) before correction.

In other words, if the two-dimensional image is projected on the screen 140 by re-forming the pixel data of each pixel of the M^{th} row according to positions of the pixels after correction, even though the keystone is generated, it is possible to allow users to visually watch the two-dimensional image having the rectangular shape in which the keystone is corrected.

In particular, a second section 610(M2)(2) of a second pixel before correction can be mapped to the pixel data of a first pixel. A first section 610(M3)(1) of a third pixel before correction can be mapped to the pixel data of the first pixel, and a second section 610(M3)(2) can be mapped to the pixel data of a second pixel. A first section 610(M4)(1), a second section 610(M4)(2) and a third section 610(M4)(3) of a fourth pixel before correction can be mapped to the pixel data of the second pixel, a third pixel and a fourth pixel, respectively.

The aforementioned relation between the pixel before correction and the pixel after correction can be varied according to the correction ratio for keystone correction.

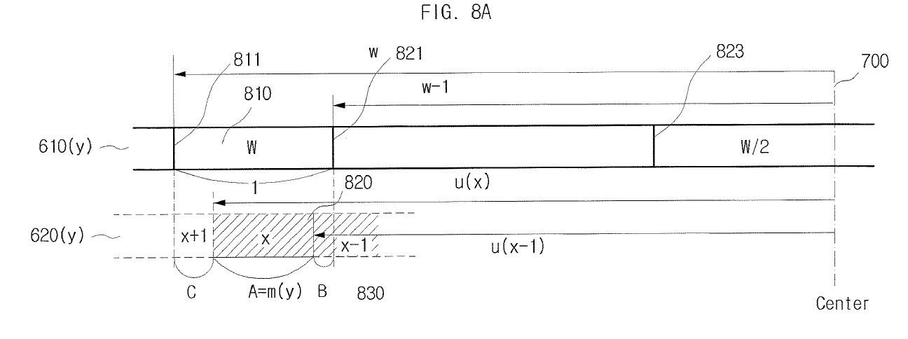

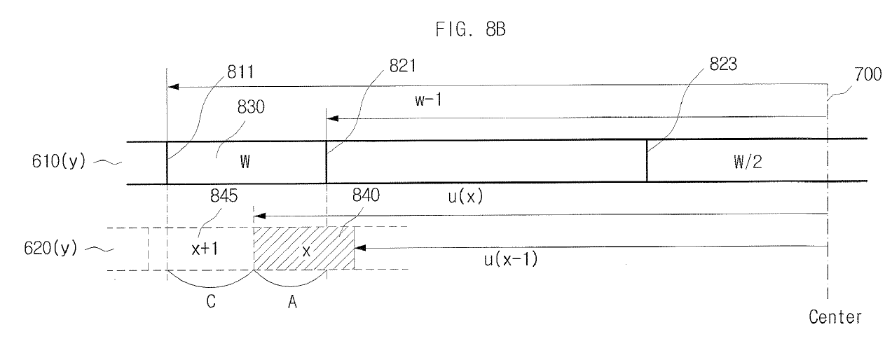

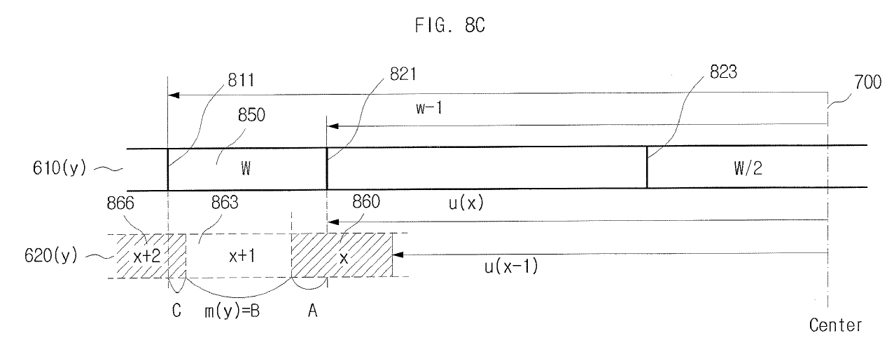

The mapping method will be described below with reference to FIG. 8A through FIG. 8C.

FIG. 8A through FIG. 8C illustrate a method of mapping pixel data per generable case for keystone correction. If a two-dimensional image is assumed to have rows in the quantities of m, the image contraction size of keystone correction of a y^{th} row is referred to as m(y). Here, 1≦y≦m. For example, referring to a x^{th} pixel of a M^{th} row, if the size of the x^{th} pixel before correction is assumed to be 1, the size of the x^{th} pixel after correction is referred to as m(M). Also, the y^{th} row 610(y) before correction and the y^{th} row 620(y) after correction can have the same center line 700.

Here, the image contraction size of keystone correction of each row can be predetermined or can be varied by the user input. In an embodiment of the present invention, the distance between a x^{th} pixel 820 after keystone correction and the center line 700 can be referred to as u(x). In particular, the distance u(x) can indicate the distance between the most distant part of the x^{th} pixel 820 and the center line 700.

A coordinate axis that is delimitated in units of a position of w is assumed. In the coordinate axis, the center line 700 is set as 0 and the delimitation lines 821, 822 and 823 between each pixel of the y^{th} row 610(y) before correction to which the pixel data of each pixel is desired to be mapped are determined as successive integers. [k] is the greatest one of the integers less than or equal to k as one of the mathematical symbols.

When the mapping for keystone correction is performed, three cases can be generated.

Case 1: [u(x)−m(y)]=[u(x)]—refer to FIG. 8A

The formula u(x)−m(y)=u(x−1) can be satisfied. In this case, the x^{th} pixel 820 can be completely included in a w^{th} pixel 810. In other words, the pixel data of the w^{th} pixel 810 that has already undergone the keystone correction can be determined by the pixel data of three pixels x−1, x and x+1 according to the following formula 1. Here, the coordinate of the w^{th} pixel 810 that has already undergone the keystone correction can be acquired by using the distance of the x^{th} pixel 820 before correction from the center line 700, which is [u(x)].

### [Formula 1]

P(w)=B×P(x−1)+A×P(x)+C×P(x+1)

A=m(y), B=u(x)−[u(x)−m(y)]−A, C=1−A−B

Here, P(x) indicates the pixel data of a x^{th} pixel.

Case 2: 1−m(y)<u(x)−[u(x)]<m(y)—refer to FIG. 8B

In this case, two pixels 840 and 845 can be mapped to a w^{th} pixel 830. In other words, the pixel data of the w^{th} pixel 830 that has already undergone the keystone correction can be determined by the pixel data of two pixels x and x+1 according to the following formula 2. Here, the coordinate of the w^{th} pixel 830 that has already undergone the keystone correction can be acquired by using the distance of a x^{th} pixel 840 before correction from the center line 700, which is [u(x)].

### [Formula 2]

P(w)=A×P(x)+C×P(x+1)

A=u(x)−[u(x)], C=1−A

Case 3: u(x)−[u(x)]<1−m(y)—refer to FIG. 8C

In this case, three pixels 860, 863 and 866 can be mapped to a w^{th} pixel 850. In other words, the pixel data of the w^{th} pixel 850 that has already undergone the keystone correction can be determined by the pixel data of three pixels x, x+1 and x+2 according to the following formula 3. Here, the coordinate of the w^{th} pixel 850 that has already undergone the keystone correction can be acquired by using the distance of a x^{th} pixel 860 before correction from the center line 700, which is [u(x)].

### [Formula 3]

P(w)=A×P(x)+B×P(x+1)+C×P(x+2)

A=u(x)−[u(x)], B=m(y), C=1−A−B

Alternatively, in the case of the case 3, the pixel data can be computed by re-grouping the case 3 as the case 1 based on a (x+1)^{th} pixel before correction.

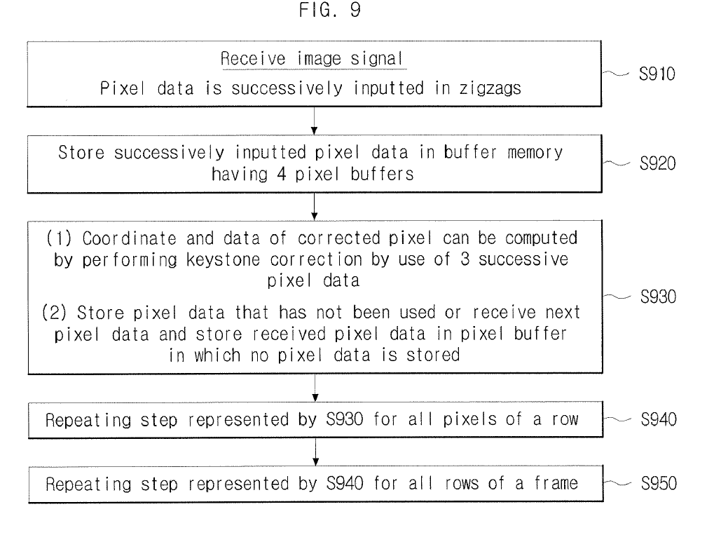

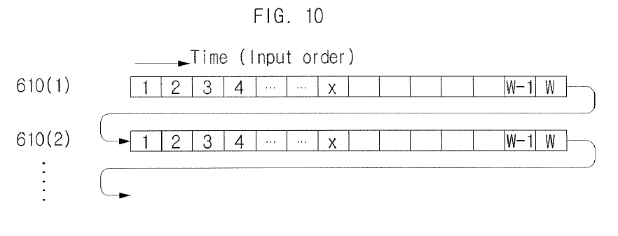

Hereinafter, the digital keystone correction method of the image processing unit 150 will be described in detail with reference to FIG. 9 and the relative drawings.

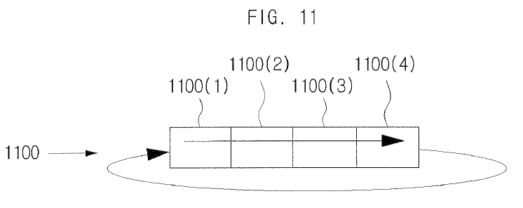

FIG. 9 is a flowchart illustrating a digital keystone correcting method in accordance with an embodiment of the present invention, and FIG. illustrates the order of inputting pixel data of an image signal. FIG. 11 illustrates the structure of a buffer memory for keystone correction in accordance with an embodiment of the present invention.

In a step represented by S910, the image processing unit 150 can receive an image signal. The image signal can include the pixel data of each pixel forming one 2-dimensional image. When the image signal is received, the pixel data of a first row 610(1) is inputted pixel by pixel in a horizontal (i.e. row) directional, and then the pixel data can be successively inputted in the order of a second row 610(2) and a third row 610(3), that is, in zigzags.

In a step represented by S920, the image processing unit 150 can successively store the pixel data in a buffer memory in order to correct the keystone, which has described with reference to FIG. 5 through FIG. 8C, (refer to FIG. 11). The buffer memory 1100 can have four pixel buffers 1100(1) through 1100(4) to store four pixel data.

In a step represented by S930, a coordinate and data of a correction pixel by using 3 successive pixel data of 4 pixel data stored in the 4 pixel buffer of the buffer memory 1100. In this case, the pixel data can be computed by the suitable case among the 3 cases described with reference to FIG. 8A through FIG. 8C.

Simultaneously, the pixel data of the pixel buffer, which has not been used for the foregoing computation, among the 4 pixel buffers of the buffer memory 1100 can be stored or a next pixel datum can be received and stored in the pixel buffer in which no pixel data is stored.

Below is described the details.

Firstly, if pixel data is stored in a first pixel buffer 1100(1) through a third pixel buffer 1100(3) of 4 pixel buffers included in the buffer memory 1100, a coordinate and data of a corrected pixel can be computed by using 3 pixel data. At the same time, a fourth pixel datum can be received and stored in a fourth pixel buffer of the buffer memory 1100.

Then, the fourth pixel data is completed to be stored, a coordinate and data of a corrected pixel can be computed by using 3 pixel data stored in a second pixel buffer 1100(2) through a fourth pixel buffer 1100(4) of the 4 pixel buffers of the buffer memory 1100. At the same time, a fifth pixel datum can be received and stored in the first pixel buffer of the buffer memory 1100.

In a step represented by S940, the keystone correction can be completed for all pixels in a row by repeating the step represented by 930.

In a step represented by S950, a correction image signal corrected with the keystone for the overall two-dimensional image can be acquired by repeating the step represented by S940 for all rows of one frame.

In the buffer memory 1100, three pixel buffers can be always used to compute a coordinate and data of a keystone-corrected pixel, and one pixel buffer can be required to receive and store a next pixel datum. Accordingly, the buffer memory 1100 can consist of at least 4 pixel buffers.

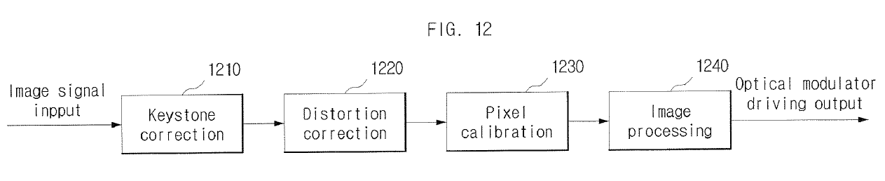

FIG. 12 illustrates the relation between a keystone corrected block and another corrected block in accordance with an embodiment of the present invention.

Referring to FIG. 12, in the image processing unit 150, a keystone correction operation 120 can be prior to other blocks such as a distortion correction operation 1220, a pixel calibration operation 1230 and the image processing operation 1240.

In the embodiment of the present invention, the keystone correction can be performed for an inputted image signal, and then, other corrections can be performed. This is to use the pixel data of an image signal inputted firstly in a horizontal direction in order to perform the keystone correction by using a first buffer memory.

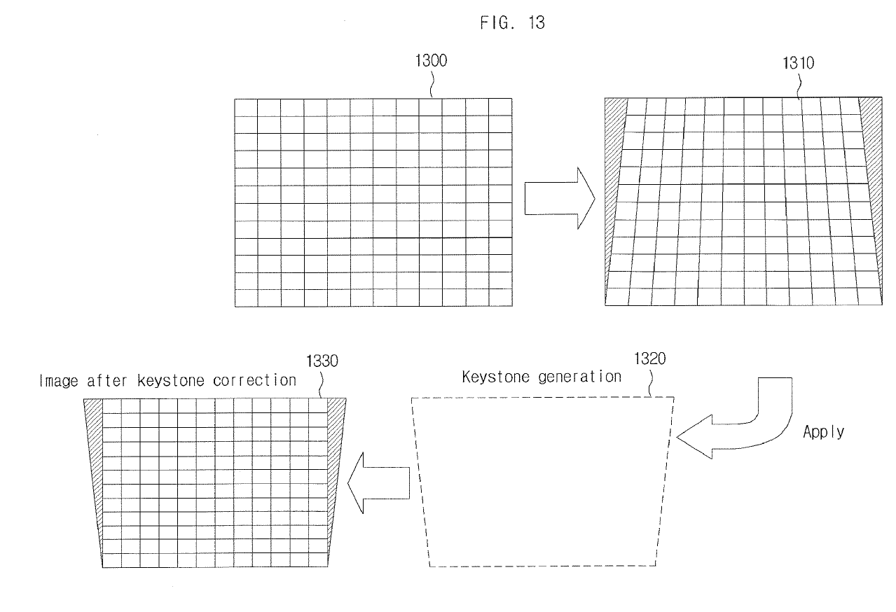

FIG. 13 illustrates an original image, a keystone corrected image and a final image projected on a screen by using a display apparatus in accordance with an embodiment of the present invention.

A first original image 1300 is illustrated in FIG. 13. If the first original image 1300 is keystone-corrected, an image 1310 including pixel data having inverse-trapezium shapes due to keystone can be acquired. This is because the pixel data of each row is arranged in advance in their positions, which will be changed after keystone is generated, for the keystone that is about to be generated.

Later, if the image 1310 is projected on a screen by using a display apparatus, a final image 1330 having rectangular shape can be displayed by the generated keystone having the trapezium shape.

Hitherto, although some embodiments of the present invention have been shown and described for the above-described objects, it will be appreciated by any person of ordinary skill in the art that a large number of modifications, permutations and additions are possible within the principles and spirit of the invention, the scope of which shall be defined by the appended claims and their equivalents.

What is claimed is:

1. A method of correcting a keystone of a display apparatus, the method comprising:
receiving a plurality of pixel data included in an image signal of a frame;
computing a coordinate and data of a correction pixel from 3 row-directionally successive pixel data of the received pixel data;
repeating the step of computing the coordinate and data of the correction pixel from all pixels of a row in the frame; and
repeating the step of repeating the step of computing the coordinate and data of the correction pixel for all rows in the frame.

2. The method of claim 1, wherein, in the step of receiving the plurality of pixel data included in the image signal, pixel data of pixels included in a row of the frame is successively inputted in a row direction, and then, pixel data of pixels included in a next row is inputted.

3. The method of claim 2, wherein the step of computing the coordinate and data of the correction pixel comprises
storing pixel data that is successively inputted in a buffer memory having 4 pixel buffers;
computing a coordinate and data of the correction pixel from 3 successive pixel data stored in each pixel buffer of the buffer memory; and
storing next pixel data in the pixel buffer that has not been used for the step of computing the coordinate and data of the correction pixel.

4. The method of claim 3, wherein the step of computing the coordinate and data of the correction pixel and the step of storing next pixel data in the pixel buffer are performed together.

5. The method of claim 1, wherein, in the step of computing the coordinate and data of the correction pixel, the coordinate of the correction pixel is computed by using a distance between a row-directional center line of the frame and a second pixel datum of the 3 successive pixel data.

6. The method of claim 1, wherein, in the step of computing the coordinate and data of the correction pixel, the data of the correction pixel is computed by determining a weight in the correction pixel of the 3 successive pixel data by use of a distance between a row-directional center line of the frame and a second pixel datum of the 3 successive pixel data.

7. A display apparatus comprising:
a projection unit, loading image information according to a correction image signal on a beam of light transferred from a light source and projecting the image information on a screen; and
an image processing unit, receiving an image signal of a frame, computing a coordinate and data of the correction pixel from 3 row-directionally successive pixel data of pixel data included in the received image signal, and generating and outputting the correction image signal including the correction pixel coordinate and the correction pixel data, computed by repeating the computation for all rows of the image signal and pixels in each of the rows.

8. The display apparatus of claim 7, wherein the image processing unit comprises a buffer memory including 4 pixel buffers, each of which stores one pixel data.

9. The display apparatus of claim 8, wherein each pixel buffer of the buffer memory stores pixel data of the image signal that is successively inputted in a row direction, and
the image processing unit computes a coordinate and data of the correction pixel from 3 successive pixel data stored in each pixel buffer of the buffer memory,
whereas a next pixel datum of pixel data of the image signal is stored in the pixel buffer that is not used in the image processing unit.

10. The display apparatus of claim 7, wherein the image processing unit computes the coordinate of the correction pixel by using a distance between a row-directional center line of the frame and a second pixel datum of the 3 successive pixel data.

11. The display apparatus of claim 7, wherein the image processing unit computes the data of the correction pixel by determining a weight in the correction pixel of the 3 successive pixel data by use of a distance between a row-directional center line of the frame and a second pixel datum of the 3 successive pixel data.

12. The display apparatus of claim 7, wherein the projection unit comprises
an optical modulator, outputting a modulated beam of light corresponding to an linear image by modulating an incident beam of light according to an inputted driving signal;
a driving circuit, converting the inputted image control signal to the driving signal and outputting the driving signal to the optical modulator;
a scanner, rotating according to a scanner control signal to scan the modulated beam of light transferred from the optical modulator on a screen and displaying a two-dimensional image; and
the light source, emitting the incident beam of light to the modulator according to an inputted light source control signal,
whereas the image processing unit controls an image projection performed by the optical modulator by providing the light source and the scanner with the light source control signal and the scanner control signal, synchronized with the image control signal.

13. The display apparatus of claim 12, wherein a plurality of micro-mirrors, arranged in a line to reflect the incident beam of light; and
driving means, moving the micro-mirrors up and down according to the driving signal,
whereas each of the micro-mirrors deals with an pixel of the screen.
